(19) United States
(12) Patent Application Publication
(10) Pub. No.: US 2016/0242396 A1
(43) Pub. Date: Aug. 25, 2016

(54) AQUASCAPING SYSTEM

(71) Applicant: CURRENT-USA, INC., VISTA, CA (US)

(72) Inventor: DENNIS FREDRICKS, Escondido, CA (US)

(73) Assignee: CURRENT-USA, INC., Vista, CA (US)

(21) Appl. No.: 14/628,136

(22) Filed: Feb. 20, 2015

(51) Int. Cl. A01K 63/00; A01K 63/04; A01K 63/06

(52) U.S. Cl. CPC A01K 63/006; A01K 63/06; A01K 63/042

(57) ABSTRACT

An aquascaping system is provided, comprising a mat positioned along a bottom surface of an enclosure, and a plurality of openings in the mat dimensioned to receive a seascaping component. These opening can include an opening for releasably receiving a rock, an opening for releasably receiving a plant, and an opening for releasably receiving landscape lighting.

### TECHNICAL FIELD

The present disclosure relates to aquascaping systems for aquariums, terrariums and other enclosures. More particularly, some embodiments are directed toward aquascaping systems that include seascape features and lighting to create desired effects in aquariums.

### DESCRIPTION OF THE RELATED ART

Conventional aquariums can include landscaping features such as plants, rocks, sand, driftwood, treasure chests, etc. These features are typically purchased and installed separately, and required periodic maintenance once installed. Installation is typically difficult and time-consuming. Furthermore, after installation, plants and other landscaping features often become loose and float to the top of the aquarium, thus requiring regular maintenance. Additionally, rocks and sand must be replaced and/or cleaned on a regular basis. As such, there are no current systems available that provide an aquascaping system that is simple to install and requires minimal maintenance thereafter.

### BRIEF SUMMARY OF THE DISCLOSURE

According to one embodiment, an aquascaping system comprises a mat positioned along a bottom surface of an enclosure, and at least one opening in the mat dimensioned to receive a seascaping component. The seascaping component can comprise, for example, one or more of a plant, a rock, landscape lighting, and driftwood. The mat can further comprise: (i) at least one internal channel within the mat for the passage of electrical wires for connecting electrical components to a power source; and (ii) at least one internal cavity within the mat for housing a power source or a heater. The mat can comprise a one-piece mat or a modular mat including a plurality of interconnected mat components. The aquascaping system can also include landscape lighting inserted in an opening of the mat such that only the light emanating from the opening is visible to a viewer of the aquarium.

In another embodiment, an aquascaping system comprises a mat positioned along a bottom surface of an enclosure, and a plurality of openings in the mat dimensioned to receive a seascaping component, comprising: (i) an opening for releasably receiving a rock; (ii) an opening for releasably receiving a plant; and (iii) an opening for releasably receiving lighting. The aquascaping system may further include an opening for releasably receiving driftwood, an opening for releasably receiving a fogger, and/or an opening for releasably receiving an air stone for creating a constant or periodic stream of air bubbles. In some embodiments, the aquascaping system follows a predetermined geographical theme selected from the group consisting of: tropical sea theme; deep ocean theme; and river or lake theme. In other embodiments, the aquascaping system follows a predetermined seasonal theme selected from the group consisting of: Summer theme; Spring theme; Winter theme; and Fall theme. In additional embodiments, the aquascaping system follows a predetermined holiday theme selected from the group consisting of: Halloween theme; Thanksgiving theme; and Christmas theme.

Other features and aspects of the disclosure will become apparent from the following detailed description, taken in conjunction with the accompanying drawings, which illustrate, by way of example, the features in accordance with embodiments of the disclosure. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments. They do not limit the breadth, scope, or applicability of the invention. It should be noted that for clarity and ease of illustration these drawings are not necessarily made to scale.

FIG. 1 illustrates an example environment for implementing exemplary lighting control systems according to one embodiment of the present disclosure.

FIG. 2 illustrates an example aquarium containing an aquascaping system in accordance with an embodiment of the disclosure.

FIG. 3 illustrates an example aquascaping system including a one-piece mat in accordance with an embodiment of the disclosure.

FIG. 4 illustrates an example aquascaping system including a modular mat in accordance with an embodiment of the disclosure.

FIG. 5 is a diagram illustrating how the modular mat components of the modular mat of FIG. 4 are interconnected.

FIG. 6A is a cross-sectional view illustrating an embodiment of the air line for the passage of air and electrical wires.

FIG. 6B, is a cross-sectional view illustrating another embodiment of the air line for the passage of air and electrical wires.

FIG. 7 is a schematic illustrating a combination airline hose and LED wire connected to an air pump and LED controller for illuminating an ornament in accordance with an embodiment of the disclosure.

FIG. 8 is a schematic illustrating a combination airline hose and LED wire connected to an air pump having an integrated LED controller in accordance with an embodiment of the disclosure.

FIG. 9 is a schematic illustrating a combination airline hose/LED wire connected to two different style ornaments in accordance with an embodiment of the disclosure. Both DC wire and airline hose can be connected together if desired

FIGS. 10A-D are schematics illustrating four different ways to illuminate an aquarium ornaments and/or back wall in accordance with an embodiment of the disclosure. LED can have adjustable lens for spread/focus beam.

FIG. 11 illustrates an example computing module that may be used to implement various features of the aquascaping system disclosed herein.

### DETAILED DESCRIPTION

The present disclosure is directed toward an aquascaping system that may be utilized with aquariums and other enclosures. Various embodiments of the present disclosure provide an aquascaping system that may include a lighting control system, . . . .

The features and functionality of the lighting control system provide easy control over different lighting fixtures comprising various lighting sources. In addition, the features and functionality of some embodiments allow a user to program various lighting characteristics and effects (i.e. lighting control information) of the light fixtures such as turn on/off dates and times, the color, the brightness, and the power supplied to the lighting fixtures. A user may program the lighting characteristics and effects via different user interfaces by using different user systems. In further embodiments, multiple lighting control systems may seamlessly operate together.

The features and functionality of the lighting control system make various embodiments plug and play ready. In some embodiments, the lighting control system provides a one button control that allow a user to set on/off times, choose a specific color blend to enhance the color of a fish species, choose a location where the appropriate light sources should be adjusted and how they should be adjusted, choose a photoperiod, or choose a dimming option.

It should be noted that although the present disclosure is described within the context of aquariums, it would be appreciated by those of ordinary skill in the art that various embodiments of the present disclosure may also be utilized in applications other than aquariums, such as, for example, terrariums, reptile enclosures, horticulture, holiday lights, hatchery lighting, landscape lighting, and pond lighting.

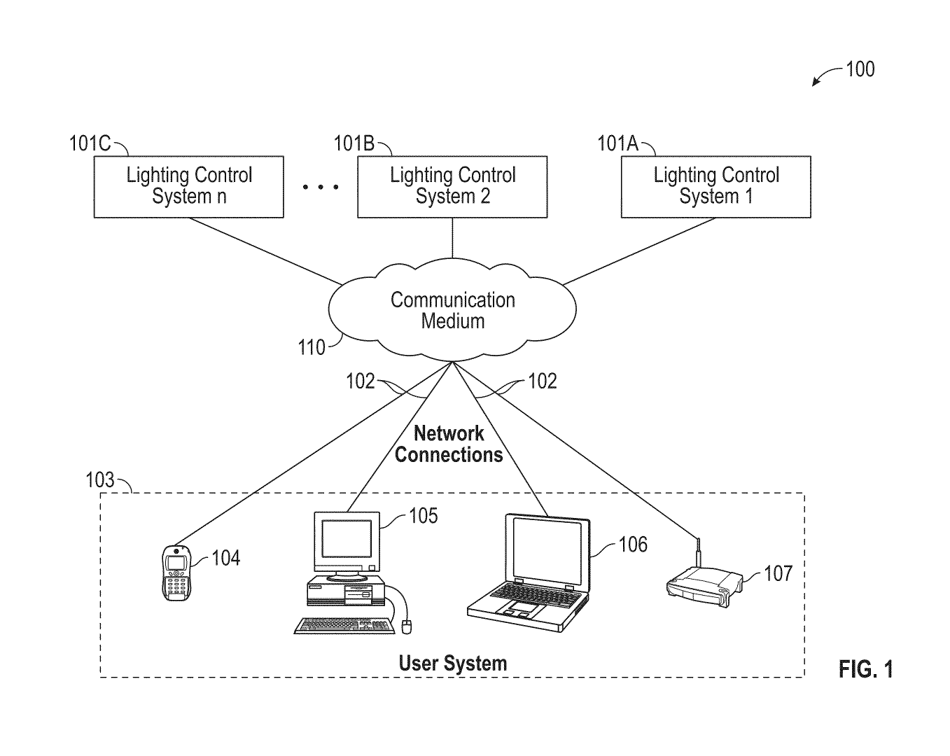

Before describing the aquascaping system in further detail, it is useful to describe an example lighting control environment in which various embodiments of the present disclosure can be implemented. One such example is described in FIG. 1.

FIG. 1 illustrates an example environment 100 for implementing exemplary control systems 101A-101C in accordance with one embodiment of the disclosure. In example environment 100, each user system 103 connects to one or more control systems 101A-101C via a network connection 102 to communication medium 110. As shown, each user system 103 such as smartphone 104 (e.g., iPhone®), desktop computer 105, laptop computer 106, and tablet 107 (e.g., iPAD®), communicates with one or more of control systems 101A-101C over communication medium 110 to control one or more lighting fixtures, audio devices, and/or ornaments having electrical features such as, e.g., a solenoid valve for control the release of air. In this example environment, control systems 101A-101C may operate seamlessly together.

Communication medium 110 may comprise any communications network such as a cellular or data network, a satellite network, an ad hoc network, an intranet, an extranet, a virtual private network (VPN), a local area network (LAN), a wireless LAN (WLAN), a wide area network (WAN), a personal area network (PAN), a portion of the Internet, a portion of the Public Switched Telephone Network (PSTN), or any combination thereof. The medium 130 may be a wireless network system such as a cellular network, a wireless personal area network, a wireless local area network, a Bluetooth system, or other similar communication medium. The medium alternatively may be a wired system, such as a coaxial cable system, a fiber optic cable system, an Ethernet cable system, a USB system, or other similar communication medium.

In various embodiments, a control platform is hosted by one or more of the control systems 101A-101C and made accessible to a user of a user system 103 (e.g., 104, 105, 106, and 107). In these embodiments, the user system 103 displays an interface that allows a user to interact with a control system to control or adjust the light sources of the lighting fixtures, audio devices or ornaments that are connected to the control system. For example, the user system 103 may receive an input from a user, transmit the input to one or more control systems 101A-101C, and receive status updates from control systems 101A-101C. The interfaces may have different designs for different user systems 103. One of ordinary skill in the art will understand that other interfaces related to the control systems may be created to facilitate the user experience.

In one embodiment, a user may download a client component of a control system. The client component is executed locally at a user system 103 while the control system provides back-end support for the client component. In this embodiment, the control system may maintain control data, process inputs from users, control one or more lighting fixtures, audio devices or ornaments, and transmit instructions to various user systems 103. Additional features of the control system are described in co-pending U.S. patent application Ser. No. 13/772,215, filed Feb. 20, 2013, the content of which is incorporated herein by reference in its entirety.

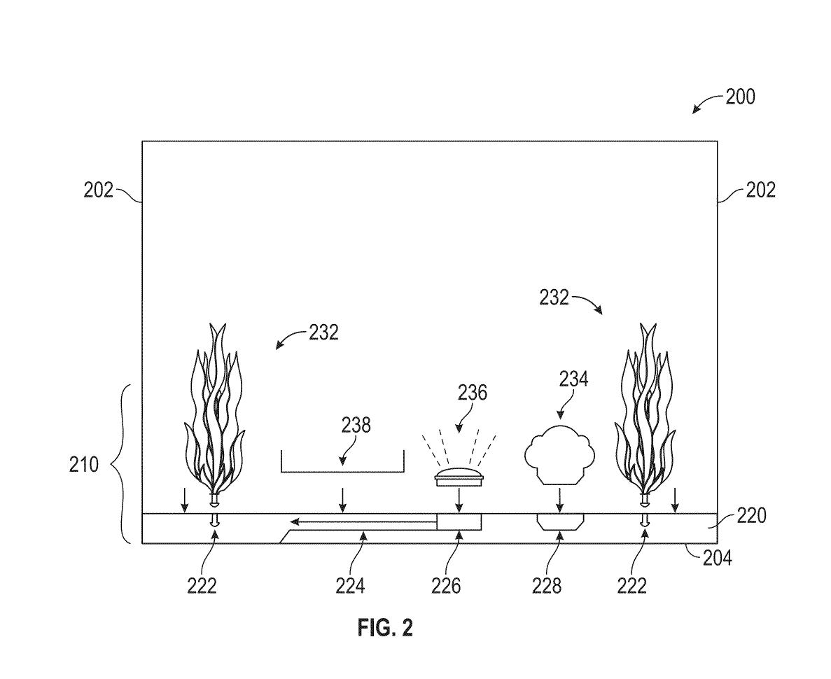

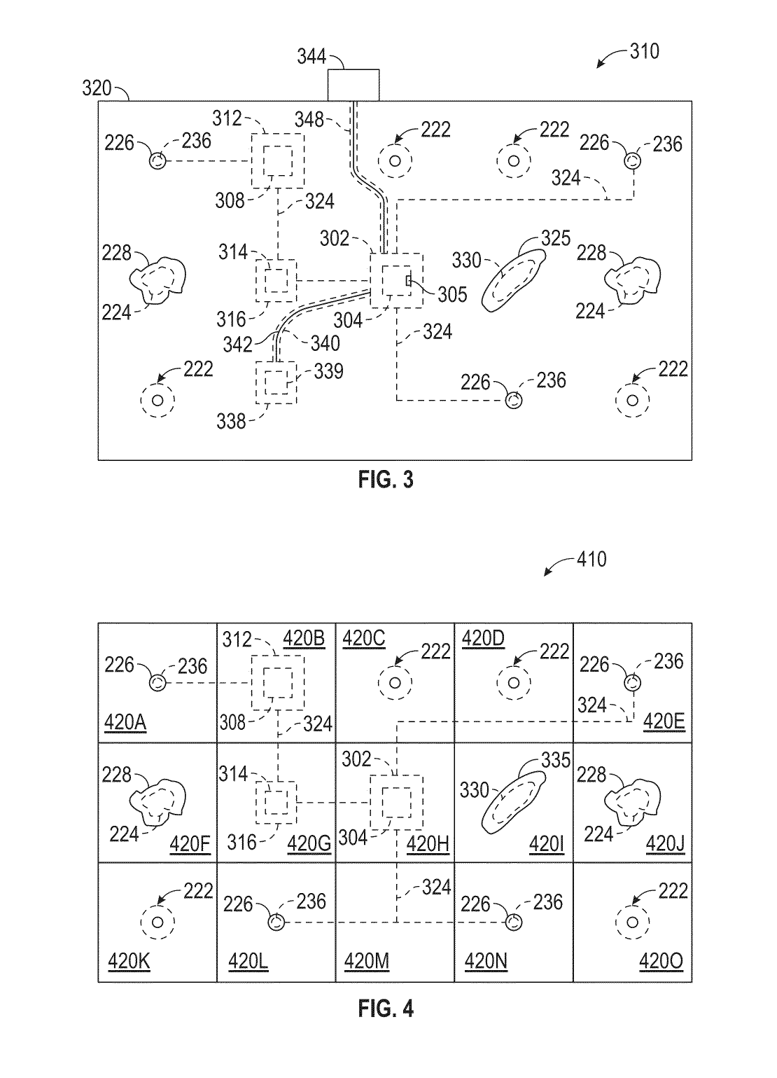

FIG. 2 illustrates an example aquarium 200 having sidewalls 202, a bottom surface 204, and containing an aquascaping system 210 in accordance with an embodiment of the disclosure. In particular, the aquascaping system 210 includes a mat 220 positioned at the bottom of the aquarium 200 having openings 222, 226, 228 for the attachment of seascaping materials such as plants 232, rock 234, landscape lighting 236, and other components/ornaments such as driftwood, air stones, volcanoes, pirate ships, treasure chests, scuba divers, claims, etc. In some embodiments, the mat 220 can further include internal channels 224 for the passage of electrical wires 238 for connecting the electrical components such as lighting 236, audio devices, one or more heaters, etc. to a power source. In such embodiments, the mat 220 can further include internal cavities containing the power source, audio device, heater, and any other electrical components. The mat 220 can be a one-piece mat such as described with respect to FIG. 3, or a plurality of modular mats such as described with respect to FIG. 4.

In one embodiment of FIG. 2, plants 232 includes a bottom tip 244 having an increased diameter such that it can be snap fit securely within opening 222 having a similar shape and size. A plant 232 can easily be removed from the mat 220 by pulling it away from the mat 220 until it pops out of the opening 222. In other embodiments, the bottom tips 244 can be secured within openings 222 by way of force fit, friction fit, fasteners, or any other suitable means of attachment. In some embodiments, the landscape lighting 236 is inserted in opening 226 of mat 320 such that only the light emanating from the opening 226 is visible to a viewer of the aquarium. In further embodiments, the landscape lighting 236 is only partially inserted in opening 226. The lighting 236 can comprise any suitable type of lighting such as one or more LEDs.

In some embodiments, the landscape lighting 236 is configured with an optical lens that provides an adjustable angular light dispersion. In particular, the variable light dispersion can be adjusted by rotating the optical lens in a clockwise or counter-clockwise manner. Such an adjustable angular light dispersion embodiment is described in U.S. Pat. No. 8,646,934, the content of which is incorporated herein by reference in its entirety.

In the embodiment in FIG. 2, the lighting 236 is a substantially cylindrical component that fits within a substantially cylindrical opening 226. In further embodiments, the lighting 236 can comprise different shapes and dimensions. The lighting 236 can be attached to opening 226 by way of snap fit such that it can be popped out of the opening 226 for service or replacement. In other embodiments, the lighting 236 can be attached by way of friction fit, force fit, fasteners, or any other suitable means of attachment. Similar to lighting 236, rock 234 is dimensioned to fit within opening 228 by way of snap fit, friction fit, force fit, fasteners, or any other suitable means of attachment.

FIG. 3 illustrates an example aquascaping system 310 including a one-piece mat 320. The one-piece mat 320 can be dimensioned to cover the entire bottom surface of an aquarium such as the aquarium 200 of FIG. 2. The illustrated one-piece mat 320 is rectangular. However, it will be understood to those of skill in the art that the mat 320 can come in any number of shapes and sizes to fit specific aquarium dimensions without departing from the scope of the disclosure. As illustrated in FIG. 3, the one-piece mat 320 includes internal cavity 302 dimensioned to house a power source 304 for powering the electrical components of the aquascaping system 310. The one-piece mat 320 further comprises internal channels 324 for the passage of electrical wires 238 embedded within the mat 320 such that they are not visible to a person viewing the aquarium. The wires 238 can be encased in plastic or other suitable material to prevent shorting if exposed to water. Electrical wires 238 provide power to the landscape lighting 236 disposed within openings 226, heater 308 disposed within internal cavity 312, fogger 314 disposed within opening 316, ornament 339 disposed within opening 338, and any other components that require electricity. These components can be coupled to control systems 101A-101C as described with respect to FIG. 1.

In some embodiments, an audio source 305 is also provided. Audio source is electrically coupled to control systems 101A-101C. It can be co-located and electrically coupled to power source 304. In one embodiment, audio source 305 is coupled to control systems 101A-101C via an audio jack. In one embodiment, the control systems 101A-101C may regulate light supplied to the lighting 236 according to sound signals from the audio source 305. A user may select the sensitivity setting and the control system 101A-101C may adjust the light based on the selected sensitivity setting (for example, low, medium or loud volumes.) For example, the lighting 236 may flash to the rhythm of medium volume of the audio source 305.

With further reference to FIG. 3, one-piece mat 320 further comprises a plurality of openings for receiving additional aquascaping components. These openings can include, but are not limited to: (i) openings 228 for rocks 234; (ii) openings 222 for various plants 232 or other aquatic vegetation; (iii) openings 226 for landscape lighting 236; (iv) opening 325 for driftwood 330; and (v) opening 316 for fogger 314. All of these components can be releasably attached to their respective openings by way of snap fit, force fit, friction fit, fasteners, or other suitable means. In some embodiments, the rock 234 can include an embedded heater (e.g. 12V) controlled by control systems 101A-101C. Further embodiments of this disclosure can include different configurations than the one depicted in FIG. 3, whereby the individual openings, channels and cavities can be arranged in any number of alternative locations. As will be appreciated by those of skill in the art, any number of additional openings may be provided for other components without departing for the scope of this disclosure. By way of example, opening 338 can be provided for an ornament 339 such as an air stone, treasure chest, volcano, scuba diver, or clam.

The ornament 339 can be controlled, for example, using control systems 101A-101C as described with respect to FIG. 1. By way of example, in an embodiment where the ornament 339 comprises a treasure chest, the opening and closing of the treasure chest can be controlled by control systems 101A-101C (e.g., using a remote control). In another embodiment where the ornament 339 comprises a volcano, the explosion of the volcano (i.e., release of bubbles, etc.) can be triggered by control systems 101A-101C. In further embodiments where the ornament comprises a scuba diver, control systems 101A-101C can be used to control the movement of the scuba diver and/or the release of a stream of bubbles. In additional embodiments where the ornament 339 comprises a claim, control systems 101A-101C can be used to control the opening of the claim shell and/or the release of bubbles. Moreover, the control systems 101A-101C can be programmed to automatically control the operation of the ornament 339 (e.g., opening of claim, release of bubbles, etc.) at predetermined times.

With continued reference to FIG. 3, internal channel 340 is provided for an air line 342 to opening 338 such that ornament 339 comprising an air stone, treasure chest, volcano, scuba diver, or clam, can create a constant or periodic stream of air bubbles. In particular, an air pump 344 can be provided to deliver air from the pump 244 to the power source 304. Under the control of control systems 101A-101C, the air pump 344 can direct the air to opening 338 via air line 342. The release of air can be controlled, e.g., using a solenoid valve controlled by the control systems 101A-101C.

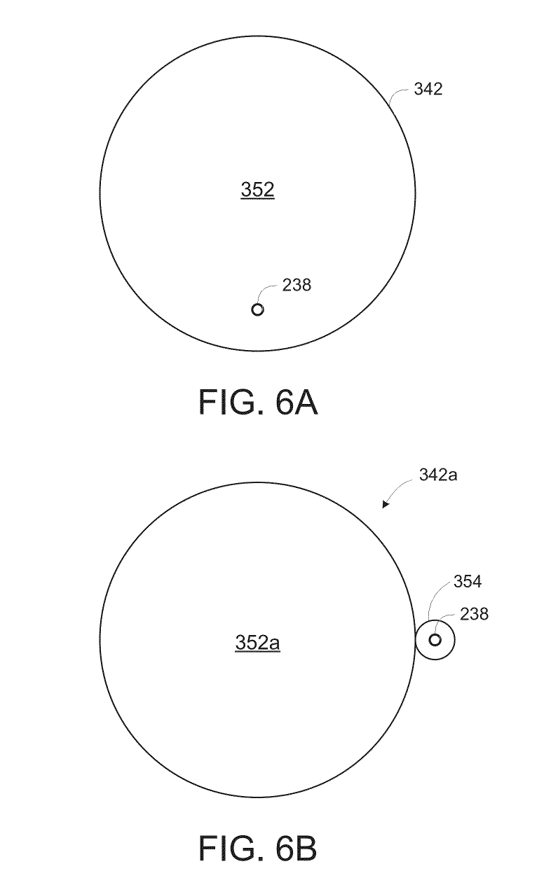

In some embodiments, air line 342 comprises a channel for the passage of air and a channel for the passage of an electrical wire to power the component 339. For example, FIG. 6A illustrates an embodiment of the air line 342 (shown in cross-section), wherein the air line 342 comprises a channel 352 for the passage of air and electrical wire 238. Alternatively, as illustrated in FIG. 6B, air line 342a comprises a channel 352a for the passage of air and a separate channel 354 for the passage of electrical wire 238. The channels 352a, 354 can be attached to each other using any conventional manner. In some embodiments, the entire mat 320 can be manufactured to include channels such as channel 352 or channel 352a to be able to supply any of the opening s in the mat with a source of air and electricity.

FIG. 4 illustrates an example aquascaping system 410 including a modular mat 420. The modular mat 420 can be dimensioned to cover the entire bottom surface of an aquarium such as the aquarium 200 of FIG. 2. Although the illustrated modular mat 420 is rectangular, it is understood that the mat 420 can come in any number of shapes and sizes to fit specific aquarium dimensions without departing from the scope of the disclosure. As illustrated in FIG. 4, the modular mat 420 comprises a plurality of individual mat components 420A-0 configured to be assembled such that they substantially cover the bottom surface of the aquarium 200. In some embodiments, the modular mat components 420A-0 are assembled in a predetermined configuration such as the configuration depicted in FIG. 4. In other embodiments, the modular mat components 420A-0 can be assembled according to the individual preferences of the user. By way of example, the user might prefer that the heater 308 is located near the rear of the aquarium and the driftwood 330 is located near the front.

With continued reference to FIG. 4, similar to the one-piece mat 320, the modular mat 420 includes internal cavity 302 dimensioned to house a power source 304 for powering the electrical components of the aquascaping system 410. The modular mat 420 further comprises internal channels 324 for the passage of electrical wires 238 embedded within the mat 320 such that they are not visible to a person viewing the aquarium. Electrical wires 238 provide power to the landscape lighting 236 disposed within openings 226, heater 308 disposed within internal cavity 312, fogger 314 disposed within opening 316, and any other components that require electricity. Modular mat 420 further comprises a plurality of openings for receiving additional aquascaping components, including, but are not limited to: (i) openings 228 for rocks 234; (ii) openings 222 for various plants 232 or other aquatic vegetation; (iii) openings 226 for landscape lighting 236; (iv) opening 325 for driftwood 330; and (v) opening 316 for fogger 314. All of these components can be releasably attached to their respective openings by way of snap fit, force fit, friction fit, fasteners, or other suitable means. As will be appreciated by those of skill in the art, any number of additional openings may be provided for other components without departing for the scope of this disclosure.

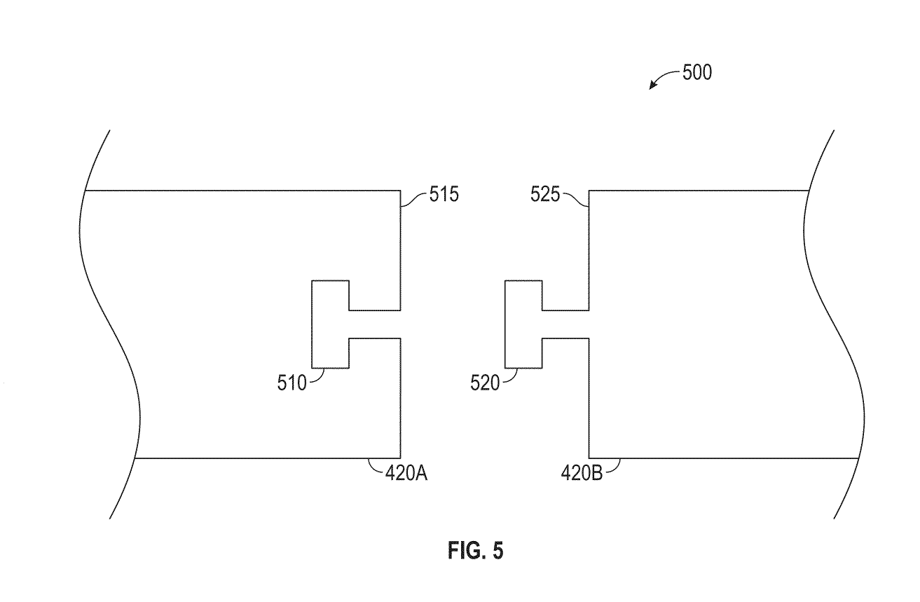

FIG. 5 depicts an embodiment 500 of the modular mat 420 showing one implementation of how the individual mat components 420A-B are interconnected. In the illustrated embodiment, modular mat component 420A is releasably attached to modular mat component 420B by way of a tongue 520 disposed along a sidewall 525 of component 420B that slides into groove 510 disposed along a sidewall 515 within component 420A. Each sidewall of mat components 420A-0 can include a tongue 520 or groove 510 such that the components can be releasable connected together in the configuration depicted in FIG. 4. In the illustrated embodiment, the tongue 520 and groove 510 are substantially T-shaped in cross-section. As would be understood to those of skill in the art, the tongues and grooves can have other cross-sectional shapes without departing from the scope of the disclosure. In further embodiments, the individual mat components 420A-0 can be releasably connected using any conventional fasteners including hook-and-loop fasteners, etc. In additional embodiments, the individual mat components 420A-0 can be simply placed next to each other in a desired configuration.

With respect to FIGS. 2-4, the disclosed aquascaping systems 210, 310, 410 can be configured to follow a geographical theme. By way of example, the aquascaping system can be arranged to include a tropical sea theme featuring many plants and a coral reef having numerous corals releasably attached to mat openings. Other embodiments can feature different themes such as a deep ocean theme and a river or lake theme. Further aquascaping embodiments can feature seasonal themes including Summer, Spring, Winter and Fall themes. Still further aquascaping embodiments can feature various holiday themes such as Halloween, Thanksgiving and Christmas. By way of example, a Christmas theme can include landscape lighting featuring the colors red, white and green, whereas a Halloween these can feature orange landscape lighting.

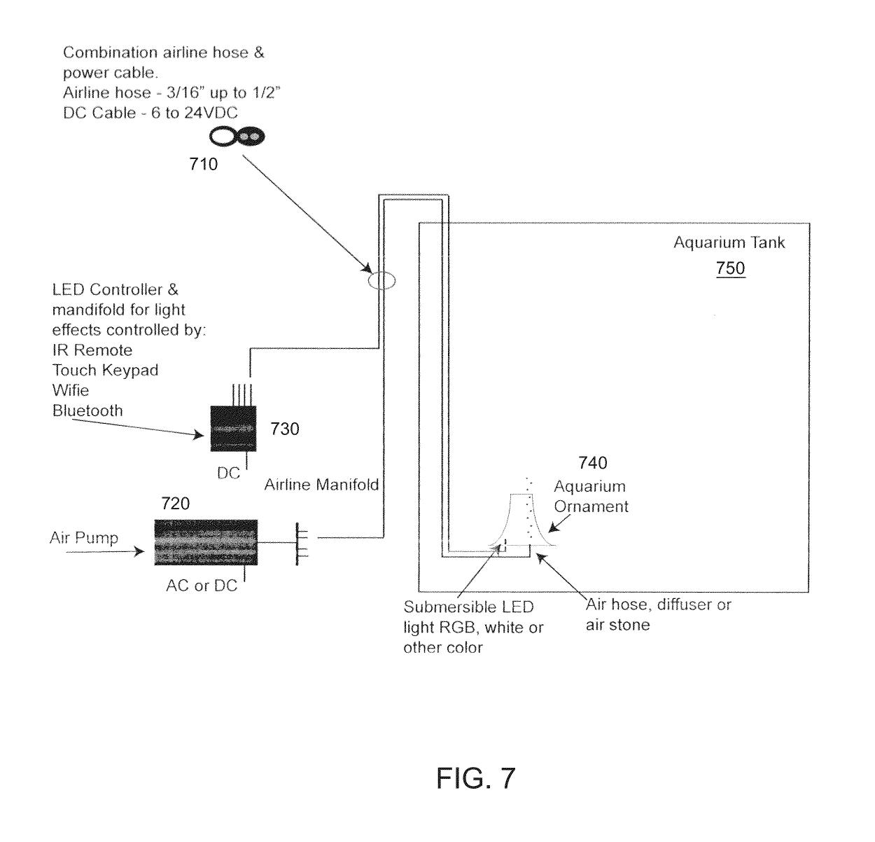

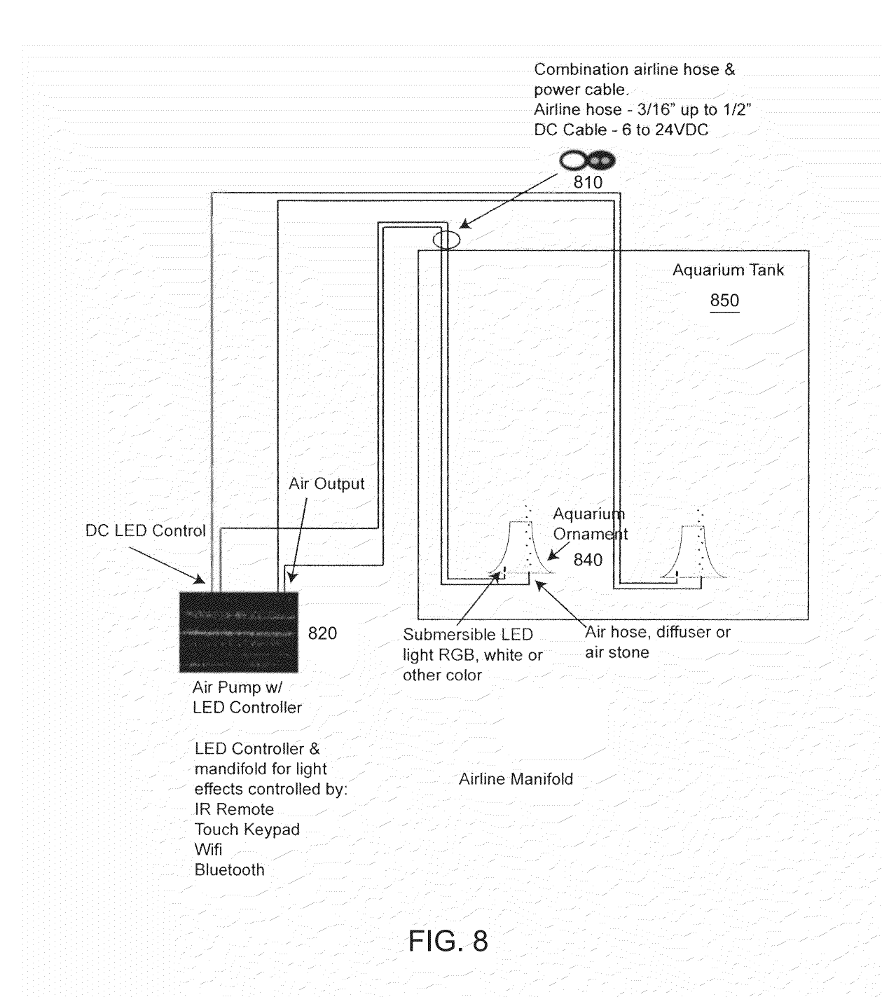

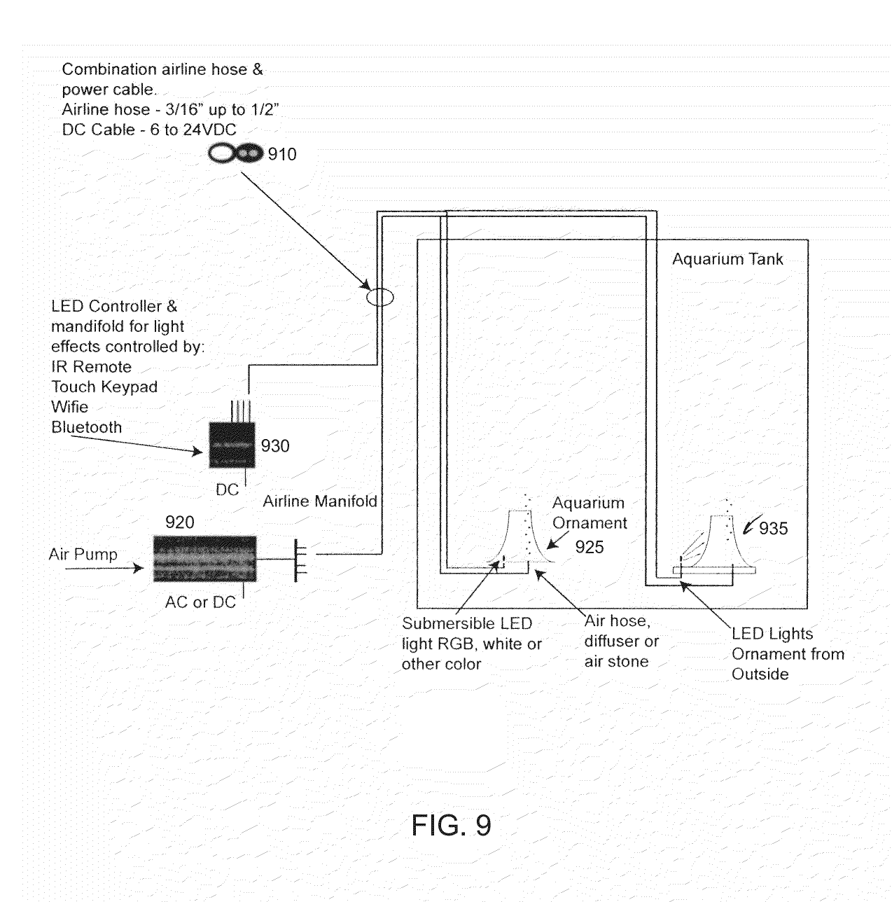

FIG. 7 is a schematic illustrating a combination airline hose and LED wire 710 connected to an air pump 720 and LED controller 730 for illuminating an ornament 740 within aquarium tank 750 in accordance with an embodiment of the disclosure. FIG. 8 is a schematic illustrating a combination airline hose and LED wire 810 connected to an air pump 820 having an integrated LED controller for illuminating an ornament 840 within aquarium tank 850 in accordance with an embodiment of the disclosure. FIG. 9 is a schematic illustrating a combination airline hose and LED wire 910 connected to two different style ornaments 925, 935 within aquarium tank 950 in accordance with an embodiment of the disclosure. The combination airline hose and LED wire 910 is also connected to air pump 920 and LED controller 930, similar to the embodiment of FIG. 7. In some configurations of the above embodiments, both the DC wire and airline hose are connected together.

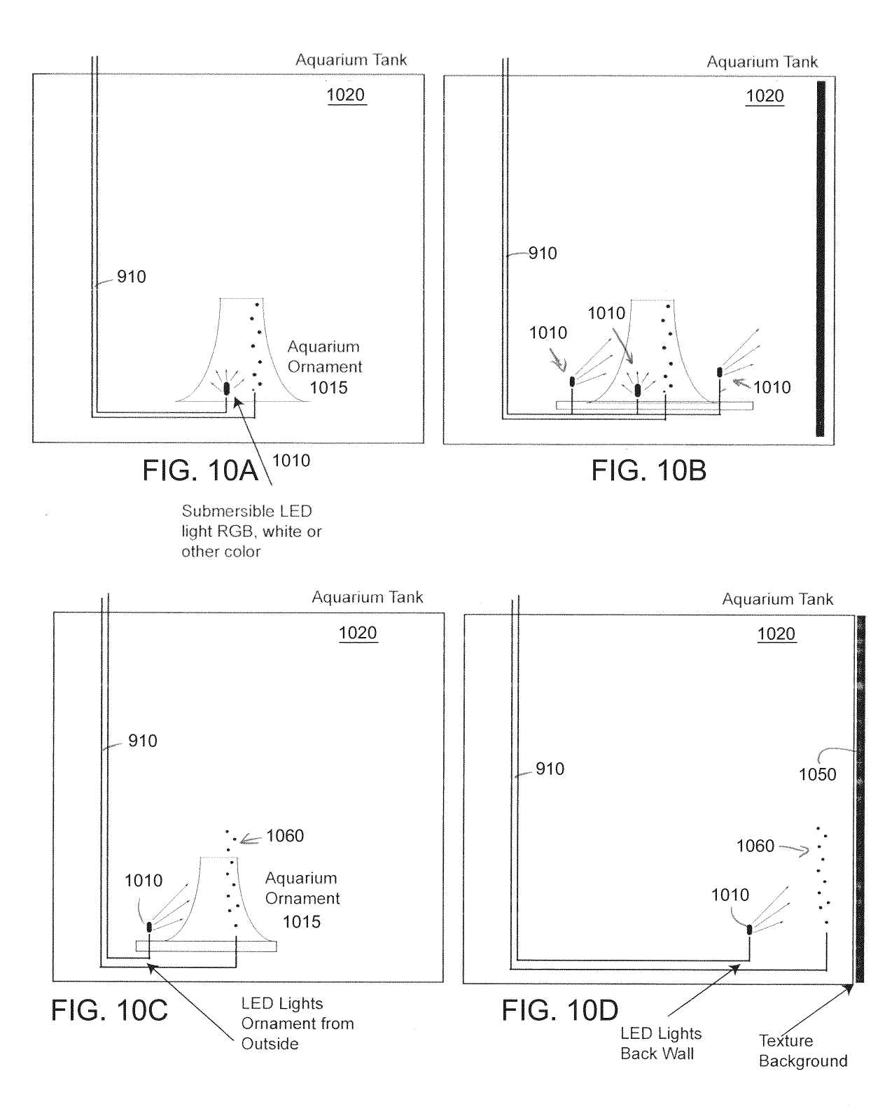

FIGS. 10A-D are schematics illustrating four different ways to illuminate an aquarium ornaments and/or back wall in accordance with an embodiment of the disclosure. Specifically, FIG. 10A depicts a submersible LED light 1010 attached to a conduit (e.g., combination airline hose and LED wire 910) for illuminating ornament 1015 from within the ornament itself. FIG. 10B shows a similar embodiment featuring a plurality of LED lights 1010, some positioned within the ornament, and others lighting the ornament from the outside. FIG. 10C illustrates another embodiment featuring an LED light 1010 the illuminates the ornament 1015 from outside of the ornament itself. Finally, FIG. 10D depicts an embodiment including an LED light 1010 that illuminated a back wall 1050 of aquarium tank 1020. Each LED light 1010 can comprise RGB, white or any other color. In some embodiments, the LED light 1010 can have an adjustable lens for spread/focus beam. Additionally, a stream of bubbles 1060 can be supplied to any ornament, or to any location within aquarium 1020, by way of combination airline hose and LED wire 910.

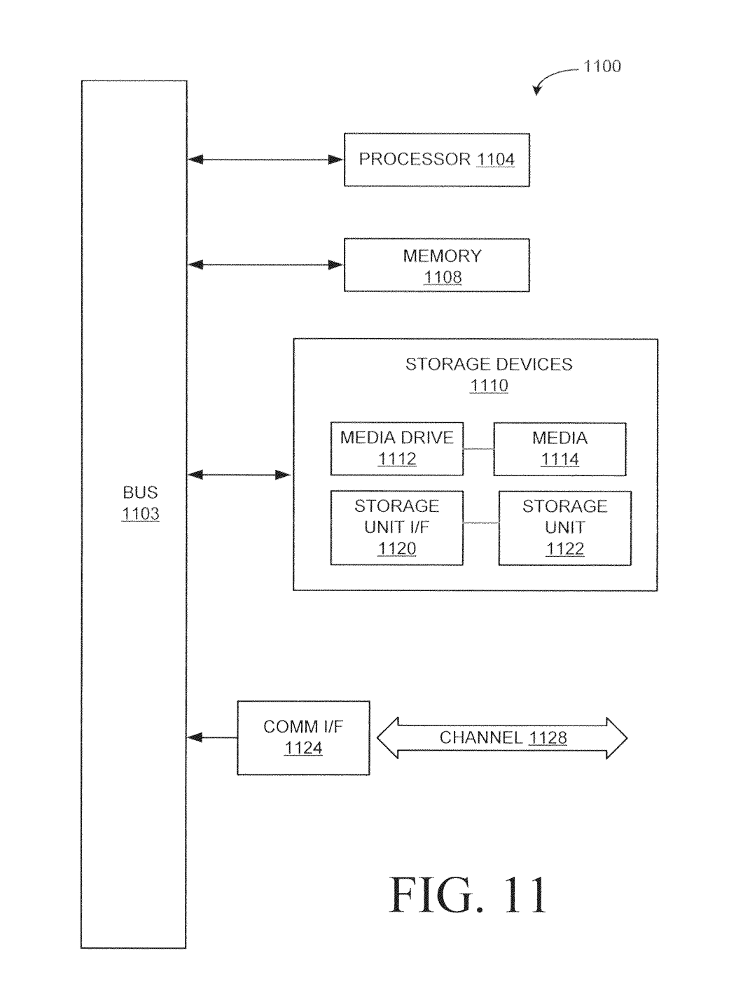

FIG. 11 illustrates an example computing module that may be used to implement various features of the lighting control system disclosed herein.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 1100. After reading this description, it will become apparent to a person skilled in the relevant art how to implement the application using other computing modules or architectures.

Referring now to FIG. 11, computing module 1100 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1100 might include, for example, one or more processors, controllers, control modules, or other processing devices, such as a processor 1104. Processor 1104 might be implemented using a general-purpose or special-purpose processing engine such as, for example, a microprocessor, controller, or other control logic. In the illustrated example, processor 1104 is connected to a bus 1102, although any communication medium can be used to facilitate interaction with other components of computing module 1100 or to communicate externally.

Computing module 1100 might also include one or more memory modules, simply referred to herein as main memory 1108. For example, preferably random access memory (RAM) or other dynamic memory, might be used for storing information and instructions to be executed by processor 1104. Main memory 1108 might also be used for storing temporary variables or other intermediate information during execution of instructions to be executed by processor 1104. Computing module 1100 might likewise include a read only memory (“ROM”) or other static storage device coupled to bus 1102 for storing static information and instructions for processor 1104.

The computing module 1100 might also include one or more various forms of information storage mechanism 1110, which might include, for example, a media drive 1112 and a storage unit interface 1120. The media drive 1112 might include a drive or other mechanism to support fixed or removable storage media 1114. For example, a hard disk drive, a solid state drive, a magnetic tape drive, an optical disk drive, a CD or DVD drive (R or RW), or other removable or fixed media drive might be provided. Accordingly, storage media 1114 might include, for example, a hard disk, an integrated circuit assembly, magnetic tape, cartridge, optical disk, a CD or DVD, or other fixed or removable medium that is read by, written to or accessed by media drive 1112. As these examples illustrate, the storage media 1114 can include a computer usable storage medium having stored therein computer software or data.

In alternative embodiments, information storage mechanism 1110 might include other similar instrumentalities for allowing computer programs or other instructions or data to be loaded into computing module 1100. Such instrumentalities might include, for example, a fixed or removable storage unit 1122 and an interface 1120. Examples of such storage units 1122 and interfaces 1120 can include a program cartridge and cartridge interface, a removable memory (for example, a flash memory or other removable memory module) and memory slot, a PCMCIA slot and card, and other fixed or removable storage units 1122 and interfaces 1120 that allow software and data to be transferred from the storage unit 1122 to computing module 1100.

Computing module 1100 might also include a communications interface 1124. Communications interface 1124 might be used to allow software and data to be transferred between computing module 1100 and external devices. Examples of communications interface 1124 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1124 might typically be carried on signals, which can be electronic, electromagnetic (which includes optical) or other signals capable of being exchanged by a given communications interface 1124. These signals might be provided to communications interface 1124 via a channel 1128. This channel 1128 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1108, storage unit 1120, media 1114, and channel 1128. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1100 to perform features or functions of the present application as discussed herein.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. An aquascaping system, comprising:
a mat positioned along a bottom surface of an enclosure;
at least one opening in the mat dimensioned to receive a seascaping component.

2. The aquascaping system of claim 1, wherein the seascaping component comprises a plant, a rock, landscape lighting, or driftwood.

3. The aquascaping system of claim 1, further comprising at least one internal channel within the mat for the passage of electrical wires for connecting electrical components to a power source.

4. The aquascaping system of claim 1, further comprising an air pump and at least one internal channel within the mat for the passage of air from the pump to an ornament located in an opening in the mat.

5. The aquascaping system of claim 1, further comprising at least one internal cavity within the mat for housing a power source or a heater.

6. The aquascaping system of claim 1, wherein the mat comprises a one-piece mat

7. The aquascaping system of claim 1, wherein the mat comprises a modular mat including a plurality of interconnected mat components.

8. The aquascaping system of claim 1, wherein the seascaping component comprises a plant having a bottom tip of increased diameter.

9. The aquascaping system of claim 8, wherein the bottom tip is snap fit securely within an opening of the mat.

10. The aquascaping system of claim 8, wherein the bottom tip is secured within an opening by way of force fit, friction fit, or fasteners.

11. The aquascaping system of claim 1, further comprising a lighting element inserted in an opening of the mat such that only the light emanating from the opening is visible to a viewer of the aquarium, the lighting element coupled to a power source disposed within an opening in the mat.

12. The aquascaping system of claim 10, wherein the lighting element comprises one or more LEDs.

13. The aquascaping system of claim 10, wherein the lighting element comprises an optical lens that provides an adjustable angular light dispersion.

14. The aquascaping system of claim 10, wherein the lighting element comprises back lighting for a seascaping component.

15. The aquascaping system of claim 1, further comprising a rock inserted into an opening by way of snap fit, friction fit, force fit or a fastener.

16. An aquascaping system, comprising:
a mat positioned along a bottom surface of an enclosure; and
a plurality of openings in the mat dimensioned to receive a seascaping component, comprising:
an opening for releasably receiving a rock;
an opening for releasably receiving a plant; and
an opening for releasably receiving lighting.

17. The aquascaping system of claim 16, further comprising an opening for releasably receiving driftwood.

18. The aquascaping system of claim 16, further comprising an opening for releasably receiving a fogger.

19. The aquascaping system of claim 16, further comprising an air pump and at least one internal channel within the mat for the passage of air from the pump to an ornament located in an opening in the mat, whereby the ornament is configured to create a constant or periodic stream of air bubbles.

20. The aquascaping system of claim 16, wherein the rock includes an embedded heater.

21. The aquascaping system of claim 16, wherein the aquascaping system follows a predetermined geographical theme selected from the group consisting of: tropical sea theme; deep ocean theme; and river or lake theme.

22. The aquascaping system of claim 16, wherein the aquascaping system follows a predetermined seasonal theme selected from the group consisting of: Summer theme; Spring theme; Winter theme; and Fall theme.

23. The aquascaping system of claim 16, wherein the aquascaping system follows a predetermined holiday theme selected from the group consisting of: Halloween theme; Thanksgiving theme; and Christmas theme.
